(19) United States
(12) Patent Application Publication
(10) Pub. No.: US 2026/0197752 A1
(43) Pub. Date: Jul. 9, 2026

(54) CONTROLLING NETWORK POLICIES FOR ENERGY SAVING IN A COMMUNICATION SYSTEM

(71) Applicant: RAKUTEN MOBILE, INC., Tokyo (JP)

(72) Inventors: Manmeet Singh BHANGU, Indore, Madhya Pradesh (IN); Kenichiro AOYAGI, Tokyo (JP)

(73) Assignee: RAKUTEN MOBILE, INC., Tokyo (JP)

(21) Appl. No.: 18/839,818

(22) PCT Filed: May 29, 2024
(86) PCT No.: PCT/IN2024/050634

§ 371 Date: Aug. 20, 2024

(30) Foreign Application Priority Data
Sep. 29, 2023 (IN) 202341065491
Jan. 12, 2024 (IN) 202441002501

(51) Int. Cl. H04W 52/02; H04L 41/0894; H04W 48/18

(52) U.S. Cl. CPC H04W 52/0203; H04L 41/0894; H04W 48/18

(57) ABSTRACT

The present disclosure discloses techniques for controlling network policies for energy saving in a communication system. In one embodiment, the present disclosure discloses a method which comprises obtaining, from an Operations Administration and Maintenance node, energy consumption assistance information associated with one or more Network Functions of a Core Network (CN). The method further comprises calculating, based on the obtained energy consumption assistance information, energy consumption associated with a network element that is associated with the CN. The method further comprises transmitting a request to a Policy Control Function for controlling one or more network policies when the calculated energy consumption associated with the network element exceeds a predefined energy threshold.

### CROSS-REFERENCE TO RELATED APPLICATIONS

This application claims priority to the Indian provisional patent application 202341065491 filed on Sep. 29, 2023 and the Indian provisional patent application 202441002501 filed on Jan. 12, 2024, the entire contents of which are incorporated herein by reference.

### FIELD

The present disclosure relates to controlling network policies for energy saving in a communication system.

### BACKGROUND

The information disclosed in this background section is only for enhancement of understanding of the general background of the disclosure and should not be taken as an acknowledgement or any form of suggestion that this information forms the prior art already known to a person skilled in the art.

Mobile telecommunications industry is experiencing tremendous growth in recent decades, driven by ever-increasing demand for connectivity and data services. To cater the ever increasing demand of connectivity and data services, the technology is being constantly advanced and the advances in the technology have resulted in rapid growth in the field of wireless communication technology. The latest advancement in wireless communication technology is the development of next generation wireless communication systems (e.g., 5^{th} Generation or 5G wireless systems). The 5G wireless systems aim to provide high reliability and throughput, lower latency, and support for a large number of devices compared to earlier wireless systems (e.g., 4G or 3G). The 5G wireless systems also aim at improved support of machine-to-machine communication (i.e., Internet of things) at lower cost and lower network energy consumption compared to the earlier wireless systems.

In a typical 5G wireless system, a base station and a user equipment (UE) interact with each other for communication services. The UE may connect to a 5G network using a 5G Radio Access Network (RAN) and a 5G Core Network (CN). The next generation wireless communication systems (e.g., 5G wireless systems) are expected to accommodate more demanding services, e.g., Extended Reality (XR), Artificial Intelligence (AI), Machine Learning (ML), etc. which may require higher energy consumption at device side (e.g., at UE side) as well as the network side (e.g., CN side). The impact on network and device side to support these services may be huge and sometimes unpredictable. For instance, when an operator A is deploying a communication service to meet application service requirements (e.g., a gaming application requirements), a customer (e.g., a service provider) needs to make sure that the application service does not consume significant energy for the end users (i.e., device side) as well as for the network side. Any potential high energy consumption or inefficient energy usage by the application service might prompt adjustments at the application layer within the service provider's domain to address these concerns.

Further, the advent of next generation technologies (e.g., 5G technology) and the widespread use of mobile devices is resulting in a substantial rise in energy consumption (also referred to as “energy usage”) in the telecommunications industry. The surge in energy usage has raised significant environmental concerns, primarily related to greenhouse gas emissions and the depletion of finite energy resources. Thus, many mobile network operators (MNOs) are setting up targets to reduce greenhouse gas emissions in coming years with an ultimate goal of achieving net-zero emissions. Though 5G wireless system offers improved energy-efficiency, new 5G use cases and the wider adoption of 5G wireless system may result in an increased number of sites and antennas resulting increase in carbon emissions. To cut down the emissions and increase/enhance network efficiency, MNOs are transitioning towards more sustainable practices by showing interests in powering their network using renewable energy sources.

However, in order to address the energy related issues for the wireless communications system and to enhance network energy-saving strategies, there is a need to understand different energy states within the network and implement and/or control energy saving policies in the network. Currently, energy consumption is not taken into consideration during creation of subscription policies and policy control in the network. Thus, the policy control does not accommodate any energy consumption matrices, thereby leading to sub-optimal subscription and policy framework.

### SUMMARY

To address the above-mentioned and other related problems, the present disclosure discloses techniques to control network policies for energy saving in a communication system. The disclosed techniques consider network energy consumption as a service criterion and enhance existing subscription and policy framework for exposing network energy consumption information and enforcing network policies related to subscription and policy control framework.

In one non-limiting embodiment, the present disclosure discloses a method which comprises obtaining, from an Operations Administration and Maintenance node, energy consumption assistance information associated with one or more Network Functions of a Core Network (CN). The method further comprises calculating, based on the obtained energy consumption assistance information, energy consumption associated with a network element that is associated with the CN. The method further comprises transmitting a request to a Policy Control Function for controlling one or more network policies when the calculated energy consumption associated with the network element exceeds a predefined energy threshold.

In one non-limiting embodiment, the present disclosure discloses an apparatus which is configured to obtain, from an Operations Administration and Maintenance node, energy consumption assistance information associated with one or more Network Functions of a CN. The apparatus is further configured to calculate, based on the obtained energy consumption assistance information, energy consumption associated with a network element that is associated with the CN and transmit a request to a Policy Control Function for controlling one or more network policies when the calculated energy consumption associated with the network element exceeds a predefined energy threshold.

In one non-limiting embodiment, the present disclosure discloses a non-transitory computer readable media storing one or more computer executable instructions which, when executed by an apparatus, cause the apparatus to obtain, from an Operations Administration and Maintenance node, energy consumption assistance information associated with one or more Network Functions of a CN. The one or more instructions further cause the apparatus to calculate, based on the obtained energy consumption assistance information, energy consumption associated with a network element that is associated with the CN, and transmit a request to a Policy Control Function or controlling one or more network policies when the calculated energy consumption associated with the network element exceeds a predefined energy threshold.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a high-level block diagram of an example communication system 100 for controlling network policies for network energy saving, in accordance with some embodiments of the present disclosure.

FIG. 2 illustrates an example procedural flow 200 for controlling network policies for energy saving in the communication system 100, in accordance with some embodiments of the present disclosure.

FIG. 3 illustrates a block diagram of an apparatus 300, in accordance with some embodiments of the present disclosure.

FIG. 4 shows a flowchart illustrating an example method 400 for controlling network policies for energy saving in a communication system 100, in accordance with some embodiments of the present disclosure.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

In the present disclosure, the terms like “communication system”, “communication network”, “system”, and “network” have been used interchangeably throughout the specification. In the present disclosure, the terms like “UDM network function” and “UDM” have been used interchangeably throughout the specification. In the present disclosure, the terms like “energy consumption” and “energy consumption value” have been used interchangeably throughout the specification. In the present disclosure, the terms like “predefined energy threshold value”, “predefined energy threshold”, “maximum energy consumption value” and “maximum energy consumption” have been used interchangeably throughout the specification.

In the context of present disclosure, the term “Energy Consumption” (EC) for a network element refers to an average power/energy consumption of the network element over a specified period of time.

In the context of present disclosure, the term “Energy Efficiency” (EE) for a network element may be expressed in terms of Data Volume divided by the Energy Consumption of the network element. In the case of RAN, the EE may be expressed by the Coverage Area divided by the Energy Consumption of the network element. Hence, the EE of a network element may be defined as the ratio of a chosen performance metric (such as data volume, number of users served, coverage area, etc.) to the energy consumption of the network during a specified period of time.

The goal of defining and measuring EC and EE of the network elements is to assess and optimize energy consumption and energy efficiency of communication systems for reducing energy consumption while maintaining network performance and quality of service (QoS). Such optimization of the energy consumption and energy efficiency not only contributes to cost savings but also aligns with sustainability goals by minimizing environmental impact due to various operations of the communication systems.

In the context of present disclosure, the term “Renewable Energy” refers to energy from renewable sources or energy from renewable non-fossil sources. For example (but not limited to) wind, solar, aerothermal, geothermal, hydrothermal, but not limited thereto.

In the context of present disclosure, the term “Energy Saving” may refer to reduction of Energy Consumption deriving from some actions, compared with the Energy Consumption when the actions are not taken.

As discussed in the background section, to effectively address energy-related challenges in a communication system and improve network energy-saving strategies, it is essential to understand energy consumption within the communication system and implement and/or control energy saving policies in the network. Currently, network policy and subscription frameworks do not take into account energy related information during policy creation, which can lead to inefficient subscription and policy management. This oversight can lead to inefficient energy management within the network, resulting in energy wastage and negative environmental impacts. Therefore, integrating energy-aware policies into network planning and operations is crucial for optimizing energy efficiency and minimizing environmental footprint.

The present disclosure discloses techniques for policy control to save network energy. Specifically, the present disclosure proposes a solution on Key Issue #2 of the 3GPP TR 23.700-66 i.e., “Subscription and policy control to support energy efficiency and energy saving as service criteria”, as discussed in the forthcoming paragraphs.

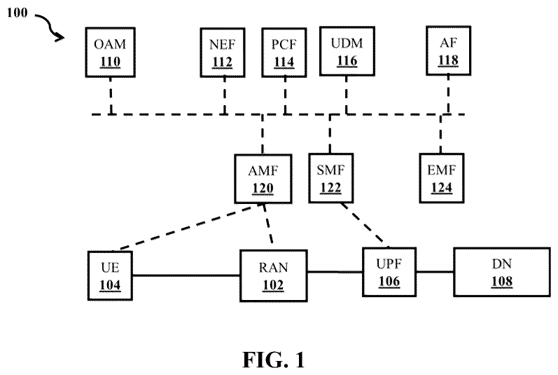

FIG. 1 illustrates a high-level block diagram of an example communication system (or a 5G system architecture) 100 for controlling network policies for energy saving in a communication system, in accordance with some embodiments of the present disclosure. The communication system 100 may comprise a core network (CN), at least one User Equipment (UE) 104 and a Radio Access Network (RAN) 102. The CN orchestrates the various network functions and services. The CN employs virtualized network functions (VNFs) and software-defined networking (SDN) principles to provide flexible and scalable connectivity services. The CN manages functions such as session management, mobility management, and service provisioning.

The at least one UE 104 may be communicatively coupled with the RAN 102. The at least one UE 104 may be any mobile or non-mobile computing device including, but not limited to, a phone (e.g., a cellular phone or smart phone), a pager, a laptop computer, a desktop computer, a wireless handset, a portable communication device, a portable computing device (e.g., a personal data assistant), an entertainment device (e.g., a music or video device, or a satellite radio), a global positioning system device, or any other suitable computing device including a wired or wireless communications interface. In some embodiments of the present disclosure, the at least one UE 104 may be Internet-of-Things (IoT)-enabled device including, but not limited to, vehicles configured to communicate with a base station or a core network.

The RAN 102 serves as a bridge between the CN and the at least one UE 104. The RAN 102 may include one or more base stations to deliver high-speed, low-latency wireless connectivity to the at least one UE 104. In the context of a fourth generation (4G) Long Term Evolution (LTE) communication system, a base station may be referred to as an “evolved NodeB” or “eNodeB,” and in the context of a fifth generation (5G) communication system, the base station may be referred to as a “gNodeB” or “gNB”. A distributed gNB can be partitioned into one or more networking applications which may include one or more central unit entities (CUs), one or more distributed unit entities (DUs), and one or more radio units (RUs). The one or more RUs may be deployed in a physical location where radio coverage is to be provided to the at least one UE 104. In the present disclosure, the term “base station” may be interchangeably used with “RAN”.

In an example embodiment, the communication system 100 shows a 5G communication system comprising a user plane and a control plane. The user plane may be configured to carry data corresponding to the users. In other words, the user plane manages actual transmission of data packets between the at least one UE 104 and different network entities. The control plane, on the other hand, is responsible for managing and controlling the communication system 100. Control plane may be configured to carry controlling traffic such as signaling traffic associated with the communication system 100. The user plane may comprise a User Plane Function (UPF) 106, which is a network function that forms a part of the 5G core network. The at least one UE 104 may connect to the UPF 106 via the RAN 102. The communication system 100 may further comprise at least one Data Network (DN) 108 which represents external networks or that interact with the core network. The DN 108 may include Internet, private networks, cloud services, or other similar communication systems.

As shown in FIG. 1, the communication system 100 may comprise at least one Operations, Administration, and Maintenance (OAM) node 110. The OAM node 110 may comprise a set of processes, protocols, and tools configured to monitor, control, troubleshoot, and optimize various aspects of the communication system 100. The various aspects may include operations, administration, and maintenance tasks. The operations tasks may comprise network functioning related tasks such as network performance monitoring, configuration management, and fault detection. The administration tasks include user management, access control, policy enforcement, and resource allocation. The maintenance tasks include software upgrades, hardware replacements, and capacity planning to accommodate growing demand. It may be noted that the arrangement of components shown in FIG. 1 is purely for illustrative purposes. Typically, the OAM node 110 is situated outside 5G Core (5GC) and interacts with various network functions of the 5GC, the RAN 102, etc.

The communication system 100 (and specifically, the control plane of the core network) may further comprise various network functions such as: one or more instances of a Network Exposure Function (NEF) 112, a Policy Control Function (PCF) 114, a Unified Data Management (UDM) 116, an Application Function (AF) 118, an Access and Mobility Management Function (AMF) 120, a Session Management Function (SMF) 122, and an Energy Management Function (EMF) 124. However, the present disclosure is not limited thereto, and it may be noted that the CN may additionally comprise other network functions such as at least one Network Repository Function (NRF), at least one Authentication Server Function (AUSF), at least one Network Slice Selection Function (NSSF), but not limited thereto.

The NEF 112 enables exposure of network capabilities to external applications and acts as an interface that allows authorized third-party applications or services to access network data and functionalities. The PCF 114 is responsible for enforcing policy decisions related to quality of service (QOS), access control, network resource allocation, but not limited thereto. The UDM network function 116 in a 5G network acts as a centralized repository for subscriber-related data and profiles. Specifically, the UDM network function 116 stores subscriber authentication credentials, subscription information, and other user-related data.

The AF facilitates integration of specialized applications or services directly into the communication system 100. The AMF 120 is responsible for managing access to a network and handling mobility-related functions for the at least UE 104. The SMF 122 is responsible for establishing, managing, and terminating data sessions between the UE 104 and different network services. Typically, the SMF 122 handles session establishment, session continuity management, and session termination. The UPF 106 is responsible for various data processing tasks including packet routing, forwarding, traffic optimization, but not limited thereto.

The core network is typically based on service-based architecture which is a system architecture in which system functionalities are achieved by a set of Network Functions (NFs) providing services to other authorized NFs to access their services. In such architecture, the various network entities of the communication system 100 may be connected together or the interactions between the network entities may be represented in two ways: point to point links (referred to as “Reference points” or reference point representations) or with Service Based Interfaces (SBIs) (or service-based representations). The NFs in 5GC use the SBIs for interactions while the interactions outside 5GC use other protocols such as Next-Generation Application Protocol (NGAP), Packet Forwarding Control Protocol (PFCP), etc. The reference points may comprise N1 (reference point between the UE 104 and the AMF 120), N2 (a reference point between the RAN 102 and the AMF 120), N3 (a reference point between the RAN 102 and the UPF 106), N4 (a reference point between the SMF 122 and the UPF 106), N6 (a reference point between the UPF 106 and the DN 108), and N9 (a reference point between two UPFs 106). A SBI represents a set of services provided or exposed by a particular NF. This is the interface where the NF service operations are invoked. The SBIs exhibited by the various NFs within the 5G core network may comprise Namf, Nsmf, Nudm, Nnrf, Nnssf, Nausf, Nnef, Npcf, Naf, Nemf, but not limited thereto.

In some embodiments of the present disclosure, the network energy related information in 5GC may be managed by the EMF 124 which may be a new network function (NF). Alternatively, or additionally, in some non-limiting embodiments, some or all functionalities of the EMF 124 may be implemented in an existing 5GC network function (e.g., the NEF, the PCF 114, but not limited thereto). The EMF 124 may be configured to calculate the energy consumption of various network elements within the communication system 100, including PDU session, network slice, but not limited thereto.

In some network deployments, measurements of network energy related information are carried out in the OAM node 110. The EMF 124 may be configured to collect energy consumption metrics from various sources within the communication system 100, such as the OAM node 110. The EMF 124 may retrieve detailed energy-related data at different granularities, such as PDU session level, network slice level, UE level, core network segment level, access network level, or network function level, but not limited thereto. To support energy consumption and efficiency as a service criterion, network energy related information needs to be accessible by the 5G Core (5GC). Once the information is stored in the 5GC, the information may be exposed to one or more authorized 3^{rd} parties (e.g., AF 118, PCF 114, etc.) e.g., to perform creation/modification of subscription policies and subsequently policy control.

The network function “EMF” 124 may also be referred to as “Energy Efficiency Control Function”, “Energy Management and Efficiency Control Function”, “EECF”, “EMECF”. In one non-limiting embodiment, the EMF 124 may obtain ratio of renewable energy (of at least one network element) from the OAM node 110. In some embodiments, the EMF 124 may obtain data amount of one single PDU session through UPF event exposure service and then calculate PDU Session energy consumption. The forthcoming paragraphs now describe the techniques of implementing policy control in the communication system 100 for network energy saving.

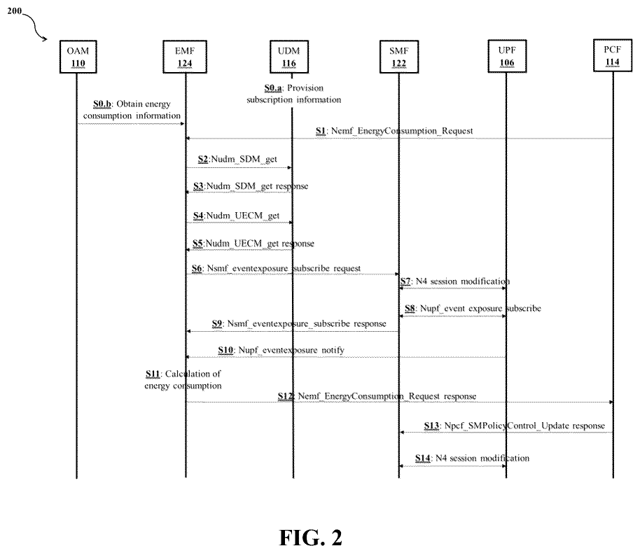

FIG. 2 illustrates an example procedural flow 200 of an energy management process within the communication system 100 to control network policies for energy saving in the communication system 100, in accordance with some embodiments of the present disclosure. Specifically, FIG. 2 illustrates interactions between different network entities for controlling network policies for energy saving in the communication system 100, in accordance with some embodiments of the present disclosure.

At Step S0.a, UE subscription information related to the maximum energy consumption per network slice for services without specific Quality of Service (QoS) criteria may be provisioned in the UDM network function 116. The maximum energy consumption (also referred to as a “predefined energy threshold” or “predefined energy threshold value”) per network slice represents a quantity of energy consumed for a specified period of time. In one embodiment, the UDM network function 116 may additionally comprise information related to maximum energy consumptions per UE, per PDU session, etc. In general, the UDM network function 116 may be provisioned with information related to maximum energy consumptions (or “predefined energy thresholds”) at different granularities (e.g., network slice level, PDU session level, UE level, access network level, network function level, but not limited thereto) in the UE subscription information.

At Step S0.b, the EMF 124 may communicate with the OAM node 110 which comprises measurements of energy consumption assistance information for different network elements (e.g., different network functions, different network slices, different PDU sessions, different UEs, etc.). The OAM node 110 may calculate and make available the energy consumption assistance information for the different network elements to different network functions. The EMF 124 may obtain energy consumption assistance information from the OAM node 110 in association with the one or more NFs of the CN. Each NF of the one or more NFs may be associated with at least one UE, at least one PDU session, and/or at least one network slice. In such cases, the energy consumption assistance information may be obtained at a specified granularity level from the one or more NFs (e.g., per UE or per PDU session or per network slice, per network function, but not limited thereto). The energy consumption assistance information for the different network elements may help in calculating energy consumption of the different network elements.

In one non-limiting embodiment, the energy consumption assistance information may include data volume or bit rate associated with the one or more NFs (specifically, associated with the UE or the PDU session or the network slice, but not limited thereto). Further, the energy consumption assistance information may include ratio of renewable energy and carbon emission information (when available at the OAM node 110).

At Step S1, the EMF 124 may receive a request (represented as “Nemf_EnergyConsumption_Request”) from the PCF 114. The request may be for energy consumption associated with a network element. The network element may comprise any logical or physical network entity such as a network slice, a network function, a UE, a PDU Session, a QoS flow, but no limited thereto. The request may comprise one or more applicable parameters such as a UE Identity (UE ID), Single-Network Slice Selection Assistance Information (S-NSSAI), and a Data Network Name (DNN) associated with the network element, but not limited thereto. For instance, if the network element is a UE, the request comprises a UE ID and other applicable parameters. Likewise, if the network element is a network slice, the request comprises a S-NSSAI and other applicable parameters. It may be noted that the energy consumption associated with the network element may be a value.

At Step S2, the EMF 124 may transmit a request to the UDM network function 116 for providing energy related provisioned data associated with the network element. This request may be represented as “Nudm_SDM_get” and may comprise identification information associated with the network element. As mentioned above, the UDM network function 116 comprises information related to maximum energy consumptions at different granularities. If the network element is a UE (i.e., the request of Step SI is for the energy consumption associated with the UE), the EMF 124 may transmit a request to the UDM network function 116 for providing maximum energy consumption or a predefined energy threshold associated with the UE. Likewise, if the network element is a PDU session (i.e., the request of Step S1 is for the energy consumption associated with the PDU session), the EMF 124 may transmit a request to the UDM network function 116 for providing maximum energy consumption or a predefined energy threshold associated with the PDU session. Similarly, if the network element is a network slice (i.e., the request of Step S1 is for the energy consumption associated with the network slice), the EMF 124 may transmit a request to the UDM network function 116 for providing maximum energy consumption or a predefined energy threshold associated with the network slice.

At Step S3, the UDM network function 116 may respond to the EMF 124 with the energy related provisioned data (or the predefined energy threshold) associated with the network element. This response may be represented as “Nudm_SDM_get response”. For example, if the network element is a network slice, the UDM network function 116 may respond with the maximum energy consumption associated with the network slice; if the network element is a PDU session, the UDM network function 116 may respond with the maximum energy consumption associated with the PDU session; and if the network element is a UE, the UDM network function 116 may respond with the maximum energy consumption associated with the UE.

At Step S4, the EMF 124 may invoke a service operation (or may transmit a request) to the UDM network function 116 to retrieve details of an appropriate SMF 122 associated with the network element. Such service operation may be represented as “Nudm_UECM_Get” service operation. The EMF 124 may provide the applicable parameters such as UE ID, DNN, S-NSSAI, and type of network function as SMF 122 (i.e., NF type=SMF).

At Step S5, the UDM network function 116 may determine the appropriate SMF 122 associated with the network element based on the received parameters i.e., the UE ID, DNN, S-NSSAI and NF type and then provide a response comprising identification information of the corresponding SMF 122 to the EMF 124. Such response may be represented as “Nudm_UECM_Get response”. In an embodiment, the identification information may comprise an identity of the SMF 122 (i.e., a SMF set ID) or an IP address of the SMF 122 (i.e., SMF IP address).

At Step S6, the EMF 124 may send a subscription request (represented as “Nsmf_eventexposure_subscribe request”) to the identified SMF 122 to subscribe to UPF data associated with the network element. The subscription request may include event filter information associated with the network element which may comprise the one or more parameters i.e., the UE ID, S-NSSAI, DNN, but not limited thereto. The EMF 124 performs this to obtain data volume (e.g., for an existing PDU session) associated with the network element (specifically corresponding to the specified UE ID, S-NSSAI, and DNN).

At Steps S7-S8, the SMF 122 and the UPF 106 may communicate with each other and select relevant network element (e.g., PDU session(s)) and UPF(s) to configure event notifications for reporting data volume metrics associated with the network element to the EMF 124. Specifically, the SMF 122 may select the network element (e.g., PDU session(s)) and the UPF(s) 106 it has to send the request to. The SMF 122 may send a request to the selected UPF 106 for the selected network element. The request may be represented as “N4 session modification” and may be indicative of user data usage measure associated with the network element. The request may include UPF event consumer address, notification correlation information, the event filter information, reporting suggestion information, target of event reporting, target subscription information, etc. This may be represented as “Nupf_event exposure subscribe”.

At Step S9, the SMF 122 may transmit a subscription response (represented as “Nsmf_eventexposure_subscribe response”) to the EMF 124 indicating successful subscription for the UPF data associated with the network element. At Step S10, the UPF 106 may transmit locally collected UPF data associated with the network element to the EMF 124. In an embodiment, the UPF 106 may invoke a service operation represented as “Nupf_eventexposure notify” to EMF 124 for transmitting the locally collected UPF data associated with the network element.

At Step S11, after receiving the UPF data, the EMF 124 may calculate energy consumption associated with the network element (e.g., PDU session) based on the received UPF data (of Step S10) and the energy consumption assistance information from Step 0.b. Specifically, at step 0.b, the EMF 124 obtains energy consumption assistance information (e.g., data volume, bit rate, etc.) from the one or more NFs. For the data volume, the EMF 124 may obtain the data amount of one single PDU session through UPF event exposure service (as discussed in steps S6-S10). In one embodiment, energy consumption associated with a network element (e.g., PDU session) may be determined by calculating a ratio of a data volume of the PDU Session (which may be obtained via the UPF event exposure service) to a total data volume of a corresponding network slice, and multiplying the calculated ratio by energy consumption associated with the network slice. Alternatively, if the energy consumption assistance information received by the EMF 124 (e.g., from the RAN 102 via the OAM node 110) and the UPF 106 are for the same UE, the EMF 124 may aggregate the energy consumption information for each UE. The energy consumption assistance information collected from the OAM node 110 may comprise energy consumption information, energy efficiency information associated with one or more network entities (e.g., RAN nodes, 5GC NFs, etc.).

At Step S12, the EMF 124 may transmit a request to the PCF 114 for controlling one or more network policies. Specifically, the EMF 124 may transmit the calculated energy consumption associated with the network element to the PCF 114. This is performed by transmitting a “Nemf_Energyconsumption_Request response” to the PCF 114. In one non-limiting embodiment, the EMF 124 may additionally transmit the maximum energy consumption (or the predefined energy threshold) associated with the network element to the PCF 114. In another non-limiting embodiment, instead of transmitting the calculated energy consumption and the maximum energy consumption, the EMF 124 may compare the calculated energy consumption and the maximum energy consumption and may transmit a result of comparison to the PCF 114.

At Step S13, upon receiving the calculated energy consumption and the maximum energy consumption associated with the network element, the PCF 114 may compare the two energy consumptions. Based on the comparison, the PCF 114 determines whether the calculated energy consumption exceeds the maximum energy consumption associated with the network element. Alternatively, upon receiving the result of comparison, the PCF 114 may determine whether the calculated energy consumption exceeds the maximum energy consumption associated with the network element.

Upon determining that the calculated energy consumption exceeds the maximum energy consumption associated with the network element, the PCF 114 may decide to control one or more network policies. The one or more network policies may comprise one or more rules. In one embodiment, controlling the one or more network policies may comprise modifying the one or more existing rules for monitoring and managing energy consumption in the system 100 (specifically, in the core network). In another embodiment, controlling the one or more network policies comprises generating one or more new rules for monitoring and managing energy consumption in the system 100 (specifically, in the core network).

In one non-limiting embodiment, the network policies may comprise Access and Mobility (AM) policies and/or Session Management (SM) policies and controlling the one or more network policies may comprise controlling/adjusting the AM policies and/or SM policies. In one embodiment, controlling the AM policies may comprise adjusting parameters including UE-Aggregate Maximum Bit Rate (UE-AMBR), UE-Slice-MBR, but not limited thereto. In one embodiment, controlling the SM policies may comprise adjusting QoS parameters, triggering PDU session release, triggering PDU session deactivation, but not limited thereto.

At Step S13, the PCF 114 may transmit the one or more modified/new rules to the SMF 122. This may be represented as “Npcf_SMPolicyControl_Update response”.

At Step S14, the SMF 122 may communicate with or may transmit a request to the UPF 106 to gate or control traffic associated with the network element (i.e., the PDU sessions or the network slice or the UE). This request may be represented as “N4 session modification”.

Thus, the EMF 124 is configured to calculate energy consumption at different granularities (e.g., PDU session granularity, UE granularity, network slice granularity, etc.) and share the energy consumption with various consumers (e.g., the PCF 114). The EMF 124 is also configured to query the UDM network function 116 to obtain details about the serving SMF 122 for specific UE, S-NSSAI, and DNN. In this manner, the EMF 124 enhances subscription procedures by provisioning maximum energy consumption limits for network elements within the communication system and enables enforcement of energy consumption policies for services that do not have QoS criteria. It may be noted that the granularity of network energy related information exposure and energy consumption may vary based on different situations.

In summary, the present disclosure provides a framework for energy saving related policy control. In the present disclosure, energy saving authorization information may be added in UE subscription information, authorizing enforcement of energy related policies. Maximum energy consumption or threshold may also be included in the UE subscription information to limit the maximum energy consumption. The techniques of the present disclosure may re-use existing AM policy and SM policies, and reuse create/update procedures of the AM/SM policies and PDU session release information as new SM policy parameter.

In some embodiments, the maximum energy consumption or the threshold may be provided by AF as well (or by the UDM), and the energy consumption assistance information is collected from 5GC NFs and/or the OAM node 110. The EMF 124 sends energy consumption information to the PCF 114, and the PCF 114 determines whether energy consumption threshold is exceeded and decides new rule. This enhances PCF's functionality to enable PCF handling “raw” energy consumption related information, which enables that the energy consumption related information is managed by two NFs.

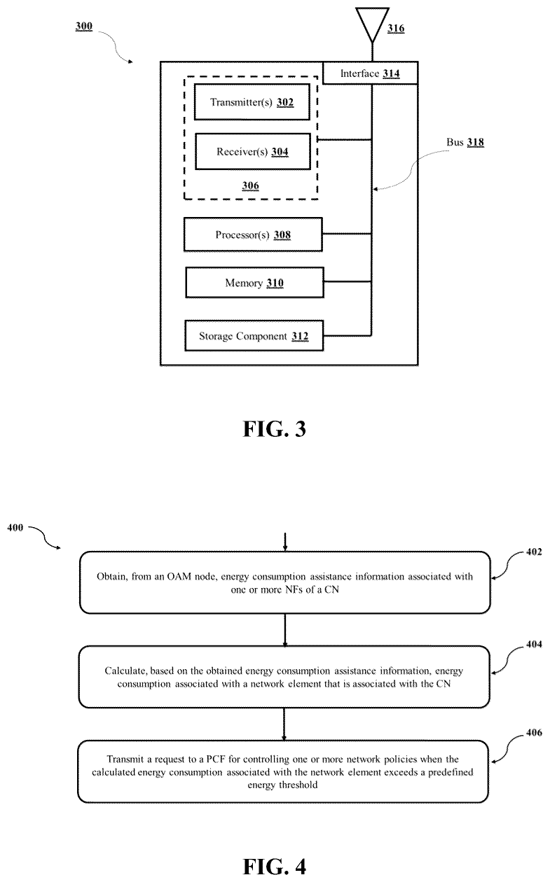

FIG. 3 illustrates a block diagram of an apparatus 300, in accordance with some embodiments of the present disclosure. As shown in FIG. 3, the apparatus 300 may comprise at least one transmitter or output component 302, at least one receiver or input component 304, at least one processor 308, at least one memory 310, at least one storage component 312, at least one interface 314, and at least one antenna 316. The at least one transmitter 302 may be configured to transmit data/information to one or more external nodes/devices using the antenna 316 and the at least one receiver 304 may be configured to receive data/information from the one or more external nodes/devices using the antenna 316. The at least one transmitter and receiver may be collectively implemented as a single transceiver or input-output module 306. In one non-limiting embodiment, the at least one processor 308 may be communicatively coupled with the transceiver 306, memory 310, storage component 312, interface 314, and antenna 316 (e.g., via a bus 318) for implementing the techniques consistent with the present disclosure. The bus 318 may include a wired interconnection or a wireless interconnection.

The at least one processor 308, as used herein, means any type of computational circuit that may comprise hardware elements and software elements. The processor 308 may be embodied as a multi-core processor, a single core processor, or a combination of one or more multi-core processors and/or one or more single core processors, a distributed processing system, or the like. The processor 308 may be a Central Processing Unit (CPU), a graphics processing unit (GPU), an accelerated processing unit (APU), an application-specific integrated circuit (ASIC), or another type of processing component.

The memory 310 may include a non-transitory computer readable medium. The memory 310 may include a random-access memory (RAM), a read only memory (ROM), and/or another type of dynamic or static storage device (e.g., a flash memory, a magnetic memory, and/or an optical memory) that stores information and/or instructions for use by processor 308. The memory 310 may comprise machine-readable instructions which are executable by the processor 308. These machine-readable instructions when executed by the processor 308 cause the processor 308 to perform one or more method steps of an embodiment described above.

The apparatus 300 may include a storage component 312 which stores information and/or software related to the operation and use of the apparatus 300. For example, the storage component 312 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The communication interface 314 is an interface that provides a communication connection to other devices, such as external devices and internal devices. The connection by the communication interface 314 can be a wired connection, a wireless connection, or a combination of wired and wireless connections, and can be a direct connection or an indirect connection via a communication system that exists between the apparatus 300 and other devices. In other words, the standard of the communication interface 314 is not limited.

The bus 318 acts as an interconnect between the processor 308, the memory 310, the storage component 312, the transmitter 302, the receiver 304, the communication interface 314, and the antenna 316 of the apparatus 300.

The number and arrangement of components shown in FIG. 3 are provided as an example. In practice, the apparatus 300 may include additional components, fewer components, different components, or differently arranged components than those shown in FIG. 3. Additionally, or alternatively, a set of components (e.g., one or more components) of the apparatus 300 may perform one or more functions described as being performed by another set of components of the apparatus 300. Further, one or more method steps described in any of the embodiments may be performed utilizing a plurality of apparatuses 300 in communication with one another.

In one non-limiting embodiment, the apparatus 300 may be used to implement some or all functions of the UE 104, the RAN 102, the core network, but not limited thereto. Specifically, the apparatus 300 may implement the functionalities of the EMF 124 and/or any other network function or network node.

Referring now to FIG. 4, a flowchart is described illustrating an example method 400 performed by a network function for controlling network policies for energy saving in a communication system 100, according to an embodiment of the present disclosure. The network function may be the EMF 124 and the functionalities of the network function 124 may be implemented with the help of the apparatus 300 (and particularly, with the help of the at least one processor 308).

The method 400 may include, at block 402, obtaining, from an OAM node 110, energy consumption assistance information associated with one or more NFs of a CN. For example, the apparatus 300 may be configured to obtain, from the OAM node 110, energy consumption assistance information associated with the one or more NFs of the CN.

In one non-limiting embodiment, obtaining the energy consumption assistance information may comprise obtaining renewal energy information and carbon emissions information associated with one or more NFs.

At block 404, the method 400 may include calculating, based on the obtained energy consumption assistance information, energy consumption associated with a network element that is associated with the CN. For example, the apparatus 300 may be configured to calculate, based on the obtained energy consumption assistance information, energy consumption associated with the network element that is associated with the CN. In one non-limiting embodiment, the network element may comprise at least one of: a PDU session associated with the CN, a UE 104 communicatively connected with the CN, a network slice associated with the CN, but not limited thereto.

At block 406, the method 400 may include transmitting a request to a PCF 114 for controlling one or more network policies when the calculated energy consumption associated with the network element exceeds a predefined energy threshold. For example, the apparatus 300 may be configured to a request to a PCF 114 for controlling one or more network policies when the calculated energy consumption associated with the network element exceeds the predefined energy threshold.

In one non-limiting embodiment, the one or more network policies may comprise one or more rules, and the step of controlling the one or more network policies may comprise modifying one or more existing rules for monitoring and managing energy consumption in the CN.

In one non-limiting embodiment, the one or more network policies may comprise one or more rules, and the step of controlling the one or more network policies may comprise generating one or more new rules for monitoring and managing energy consumption in the CN.

In one non-limiting embodiment, the method 400 may further comprise transmitting, to a UDM network function 116, a request for the predefined energy threshold associated with the network element and receiving, from the UDM network function 116, a response comprising the predefined energy threshold associated with the network element based on the request. In such an embodiment, transmitting the request to the PCF 114 for controlling the one or more network policies comprises transmitting the energy consumption and the predefined energy threshold associated with the network element.

In one non-limiting embodiment, the method 400 may further comprise receiving, from the PCF 114, a request for the energy consumption associated with the network element. The request may comprise one or more applicable parameters including a UE ID, S-NSSAI, and a DNN associated with the network element. The method 400 may further comprise in response to receiving the request for the energy consumption, transmitting the energy consumption associated with the network element to the PCF 114.

In one non-limiting embodiment, the method 400 may further comprise transmitting, to a UDM network function 116, a request for identification information of at least one SMF 122 associated with the network element. The request may comprise the UE ID, the DNN, and a network function type. The method 400 may comprise receiving, from the UDM network function 116, a response comprising the identification information of the at least one SMF associated with the network element. The identification information may comprise an identity of the at least one SMF or an Internet Protocol (IP) address associated with the at least one SMF 122.

In one non-limiting embodiment, the method 400 may further comprise obtaining an amount of data associated with the network element via an event exposure service, and calculating the energy consumption associated with the network element based at least on the amount of data associated with the network element.

In one non-limiting embodiment, the energy consumption information of the network element may be acquired based on means of averaging or applying a statistical model for the energy consumed by at least one of the one or more NFs which is associated with the network element. For example, consider that the one or more NFs comprise NF1, NF2, NF3, NF4, NF5. Each of the one or more NFs may be associated with different UEs, network slices, PDU sessions, etc. Consider that NF1, NF2, NF4 are associated with a network slice NS1.

Now, EMF 124 initially obtains energy consumption assistance information associated with NF1 to NF5 from the OAM node 110. Upon receiving the request for the energy consumption associated with NS1 and PDS1 from the PCF 114, the EMF 124 may communicate with the UDM network function 116 to obtain predefined energy thresholds corresponding to the NS1. Next, the EMF 124 may calculate energy values E1, E2, E4 associated with the NS1 which are consumed by the NF1, NF2, NF4 respectively. Next, the EMF 124 may calculate energy consumption value for the NS1 by averaging or applying a statistical model on the energy values E1, E2, and E4.

In one non-limiting embodiment, the EMF 124 may obtain an amount of data associated with NS1 via an event exposure service and calculate the energy consumption associated with the NS1 based at least on the amount of data associated with the NS1.

Though the techniques of the present disclosure have been described in the context of energy consumption information. However, the present disclosure is not limited thereto and in general energy efficiency information and renewal energy consumption information may also be used in the similar manner for controlling network policies for energy saving in the communication system.

The present disclosure discloses what enhancements may be required in the current subscription and policy frameworks of the existing communication systems to expose energy consumption of a network (e.g., 5G CN). Subsequently, this information may be used to enforce the policies related to subscription and policy control framework. The techniques of the present disclosure disclose integration of energy consumption and efficiency information of a network (including but not limited to the 5G CN) with the subscription policies and policy control framework so that energy consumption can be taken as a service criterion during creation of subscription policies and subsequently policy control.

In some embodiments, the present disclosure provides techniques for efficiently collecting and exposing the network energy related information to various stakeholders (e.g., PCF). By sharing the network energy related information (e.g., renewal energy related information), the stakeholders (e.g., PCF) gain valuable insights into carbon footprint of telecommunications operations, thus providing a foundation for informed decision-making and targeted policy control to address environmental concerns.

### Embodiments

Embodiment 1. A method comprising: obtaining, from an OAM node, energy consumption assistance information associated with one or more NFs of a CN; calculating, based on the obtained energy consumption assistance information, energy consumption associated with a network element that is associated with the CN; and transmitting a request to a PCF for controlling one or more network policies when the calculated energy consumption associated with the network element exceeds a predefined energy threshold.

Embodiment 2. The method as claimed in embodiment 1, further comprising:

transmitting, to a UDM network function, a request for the predefined energy threshold associated with the network element; and receiving, from the UDM network function, a response comprising the predefined energy threshold associated with the network element based on the request. Transmitting the request to the PCF for controlling the one or more network policies comprises transmitting the energy consumption and the predefined energy threshold associated with the network element.

Embodiment 3. The method as claimed in embodiment 1 or 2, further comprising: receiving, from the PCF, a request for the energy consumption associated with the network element, wherein the request comprises one or more applicable parameters including a UE ID, S-NSSAI, and a DNN associated with the network element; and in response to receiving the request for the energy consumption, transmitting the energy consumption associated with the network element to the PCF.

Embodiment 4. The method as claimed in embodiment 3, further comprising: transmitting, to a UDM network function, a request for identification information of at least one SMF associated with the network element, wherein the request comprises the UE ID, the DNN, and a network function type; and receiving, from the UDM, a response comprising the identification information of the at least one SMF associated with the network element, wherein the identification information of the at least one SMF comprises an identity of the at least one SMF or an IP address associated with the at least one SMF.

Embodiment 5. The method as claimed in any of embodiments 1-4, further comprising: obtaining an amount of data associated with the network element via an event exposure service; and calculating the energy consumption associated with the network element based at least on the amount of data associated with the network element.

Embodiment 6. The method as claimed in any of embodiments 1-5, wherein obtaining the energy consumption assistance information comprises obtaining renewal energy information and carbon emissions information associated with one or more NFs.

Embodiment 7. The method as claimed in any of embodiments 1-6, wherein the one or more network policies comprises one or more rules, and wherein controlling the one or more network policies comprises modifying one or more existing rules for monitoring and managing energy consumption in the CN.

Embodiment 8. The method as claimed in any of embodiments 1-7, wherein the one or more network policies comprises one or more rules, and wherein controlling the one or more network policies comprises generating one or more new rules for monitoring and managing energy consumption in the CN.

Embodiment 9. The method as claimed in any of embodiments 1-8, wherein the network element comprises at least one of: a Protocol Data Unit (PDU) session associated with the CN, and a User Equipment (UE) communicatively connected with the CN.

It may be noted here that the subject matter of some or all embodiments described with reference to FIGS. 1-2 may be relevant for the method 400 and the same is not repeated for the sake of brevity. The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the appended claims.

What is claimed is:

1. A method comprising:
obtaining, from an Operations Administration and Maintenance (OAM) node, energy consumption assistance information associated with one or more Network Functions (NFs) of a Core Network (CN);
calculating, based on the obtained energy consumption assistance information, energy consumption associated with a network element that is associated with the CN; and
transmitting a request to a Policy Control Function (PCF) for controlling one or more network policies when the calculated energy consumption associated with the network element exceeds a predefined energy threshold.

2. The method as claimed in claim 1, further comprising:
transmitting, to a User Data Management (UDM) network function, a request for the predefined energy threshold associated with the network element; and
receiving, from the UDM network function, a response comprising the predefined energy threshold associated with the network element based on the request,
wherein transmitting the request to the PCF for controlling the one or more network policies comprises transmitting the energy consumption and the predefined energy threshold associated with the network element.

3. The method as claimed in claim 1, further comprising:
receiving, from the PCF, a request for the energy consumption associated with the network element, wherein the request comprises one or more applicable parameters including a User Equipment Identity (UE ID), Single-Network Slice Selection Assistance Information (S-NSSAI), and a Data Network Name (DNN) associated with the network element; and
in response to receiving the request for the energy consumption, transmitting the energy consumption associated with the network element to the PCF.

4. The method as claimed in claim 3, further comprising:
transmitting, to a User Data Management (UDM) network function, a request for identification information of at least one Session Management Function (SMF) associated with the network element, wherein the request comprises the UE ID, the DNN, and a network function type; and
receiving, from the UDM network function, a response comprising the identification information of the at least one SMF associated with the network element, wherein the identification information of the at least one SMF comprises an identity of the at least one SMF or an Internet Protocol (IP) address associated with the at least one SMF.

5. The method as claimed in claim 1, further comprising:
obtaining an amount of data associated with the network element via an event exposure service; and
calculating the energy consumption associated with the network element based at least on the amount of data associated with the network element.

6. The method as claimed in claim 1, wherein obtaining the energy consumption assistance information comprises obtaining renewal energy information and carbon emissions information associated with one or more NFs.

7. The method as claimed in claim 1, wherein the one or more network policies comprises one or more rules, and wherein controlling the one or more network policies comprises modifying one or more existing rules for monitoring and managing energy consumption in the CN.

8. The method as claimed in claim 1, wherein the one or more network policies comprises one or more rules, and wherein controlling the one or more network policies comprises generating one or more new rules for monitoring and managing energy consumption in the CN.

9. The method as claimed in claim 1, wherein the network element comprises at least one of: a Protocol Data Unit (PDU) session associated with the CN, and a User Equipment (UE) communicatively connected with the CN.

10. An apparatus configured to:
obtain, from an Operations Administration and Maintenance (OAM) node, energy consumption assistance information associated with one or more Network Functions (NFs) of a Core Network (CN);
calculate, based on the obtained energy consumption assistance information, energy consumption associated with a network element that is associated with the CN; and
transmit a request to a Policy Control Function (PCF) for controlling one or more network policies when the calculated energy consumption associated with the network element exceeds a predefined energy threshold.

11. The apparatus as claimed in claim 10, further configured to:
transmit, to a User Data Management (UDM) network function, a request for the predefined energy threshold associated with the network element; and
receive, from the UDM network function, a response comprising the predefined energy threshold associated with the network element based on the request,
wherein to transmit the request to the PCF for controlling the one or more network policies, the apparatus is configured to transmit the energy consumption and the predefined energy threshold associated with the network element.

12. The apparatus as claimed in claim 10, further configured to:
receive, from the PCF, a request for the energy consumption associated with the network element, wherein the request comprises one or more applicable parameters including a User Equipment Identity (UE ID), Single-Network Slice Selection Assistance Information (S-NSSAI), and a Data Network Name (DNN) associated with the network element; and
in response to receiving the request for the energy consumption, transmit the energy consumption associated with the network element to the PCF.

13. The apparatus as claimed in claim 12, further configured to:
transmit, to a User Data Management (UDM) network function, a request for identification information of at least one Session Management Function (SMF) associated with the network element, wherein the request comprises the UE ID, the DNN, and a network function type; and
receive, from the UDM network function, a response comprising the identification information of the at least one SMF associated with the network element, wherein the identification information of the at least one SMF comprises an identity of the at least one SMF or an Internet Protocol (IP) address associated with the at least one SMF.

14. The apparatus as claimed in claim 10, further configured to:
obtain an amount of data associated with the network element via an event exposure service; and
calculate the energy consumption associated with the network element based at least on the amount of data associated with the network element.

15. The apparatus as claimed in claim 10, wherein to obtain the energy consumption assistance information, the apparatus is configured to obtain renewal energy information and carbon emissions information associated with one or more NFs.

16. The apparatus as claimed in claim 10, wherein the one or more network policies comprises one or more rules, and wherein to control the one or more network policies, the apparatus is configured to modify one or more existing rules for monitoring and managing energy consumption in the CN.

17. The apparatus as claimed in claim 10, wherein the one or more network policies comprises one or more rules, and wherein to control the one or more network policies, the apparatus is configured to generate one or more new rules for monitoring and managing energy consumption in the CN.

18. The apparatus as claimed in claim 10, wherein the network element comprises at least one of: a Protocol Data Unit (PDU) session associated with the CN, and a User Equipment (UE) communicatively connected with the CN.

19. A non-transitory computer readable media storing one or more computer executable instructions which, when executed by an apparatus, cause the apparatus to:
obtain, from an Operations Administration and Maintenance (OAM) node, energy consumption assistance information associated with one or more Network Functions (NFs) of a Core Network (CN);
calculate, based on the obtained energy consumption assistance information, energy consumption associated with a network element that is associated with the CN; and
transmit a request to a Policy Control Function (PCF) for controlling one or more network policies when the calculated energy consumption associated with the network element exceeds a predefined energy threshold.

20. The non-transitory computer readable media as claimed in claim 19, wherein the one or more computer executable instructions further cause the apparatus to:
transmit, to a User Data Management (UDM) network function, a request for the predefined energy threshold associated with the network element; and
receive, from the UDM network function, a response comprising the predefined energy threshold associated with the network element based on the request,
wherein to transmit the request to the PCF for controlling the one or more network policies, the one or more computer executable instructions cause the apparatus to transmit the energy consumption and the predefined energy threshold associated with the network element.
